(19) United States
(12) Patent Application Publication
(10) Pub. No.: US 2025/0163754 A1
(43) Pub. Date: May 22, 2025

(54) ROLLER SHUTTER ROD AND ROLLER SHUTTER

(71) Applicant: UNIVERSITÄTSMEDIZIN DER JOHANNES GUTENBERG-UNIVERSITÄT MAINZ, Mainz (DE)

(72) Inventor: Friedrich Karl RINN

(73) Assignee: UNIVERSITÄTSMEDIZIN DER JOHANNES GUTENBERG, Mainz (DE)

(21) Appl. No.: 18/730,744

(22) PCT Filed: Jan. 20, 2023
(86) PCT No.: PCT/EP2023/051442

§ 371 Date: Jul. 19, 2024

(30) Foreign Application Priority Data
Jan. 20, 2022 (DE) 10 2022 200 637.2

(51) Int. Cl. E06B 9/15

(52) U.S. Cl. CPC E06B 9/15; E06B 2009/1538

(57) ABSTRACT

Roller shutter rod, comprising a body with a head end and a foot end, wherein a hook is arranged at one of the two ends and a chamber for receiving the hook is formed at the other of the two ends a chamber is formed for receiving the hook, wherein the chamber is formed in two parts in such a way that it enables a hook to be received in two directions opposite to a centre plane of the roller shutter rod.

### CROSS-REFERENCE TO RELATED APPLICATION

This application is a national phase of International Application No. PCT/EP2023/051442, filed Jan. 20, 2023, which is hereby incorporated by reference in its entirety.

### FIELD

This disclosure relates generally to roller shutter rods and roller shutters.

### BACKGROUND

Almost all roller shutter systems in use today consist of so-called slide-in profiles, i.e. each individual segment of a roller shutter is hinged to the segment above it, the roller shutter rod, with a hook provided by its own profile shape. In the production of roller shutters, the roller shutter rods, which are manufactured in stock lengths or “endless”, are cut to the required width of the finished roller shutter and then connected to form a roller shutter (also known as a curtain or roller armour) by sliding them sideways into each other. In a further production step, the individual rods are secured against moving against each other.

The hook profile at the upper end of a roller shutter rod and the counterpart of the hollow chamber on the lower chamber of the roller shutter rod above are shaped in such a way that they connect the roller shutter rods to each other in an articulated manner. This allows the roller shutter to roll up onto the shaft of the roller shutter.

With conventional roller shutter profiles, it is desirable (for visual reasons) that they “stand upright”, i.e. that a visually homogeneous surface is created when the roller shutter is closed.

Dutch patent application NL 8401204 discloses a locking system for a roller shutter that prevents the shutter door from opening. The suspended slats are movable about their hinge axis. The roller shutter is guided on its sides by a profiling which has locking steps in a periodic sequence. The guide rail is profiled and forms locking steps against which the slats abut. The shutter falls under its own weight and glides smoothly over this profiling. When its lower edge reaches the floor, the slats swivel in a zig-zag motion with the swivel axes under the locking steps. Lifting the bottom slat presses the swivel axes against the steps and the roller shutter is not lifted.

The German patent application DE 28 49 199 A1 discloses a roller shutter that is secured against being pushed up by wedging the slats of the roller shutter when it is pushed up in such a way that a jamming occurs in the U-profile guide rail.

The German patent application DE 28 27 512 A1 discloses a roller shutter in which the profile of the individual slats is designed in such a way that the slats wedge into one another when the roller shutter is pushed open.

The German patent application DE 197 53 247 A1 discloses joints for roller shutter elements or rods which are designed in such a way that the roller shutter curtain wedges in the guide rail when it is pushed up. These joints are separate elements to which the roller shutter rods are connected.

European patent application EP 2 357 311 A1 discloses separate elements that connect the roller shutter rods to each other in an articulated manner. When the roller shutter is pushed up, the roller shutter rods wedge into the guide rail.

The disadvantage of conventional roller shutters is that they offer only limited wind and security protection.

### SUMMARY

This disclosure is based on the task of improving the properties of conventional roller shutter rods, roller shutters and roller doors, as they correspond to the current state of the art, in such a way that they have improved properties in terms of wind and provide automatic protection against being pushed up.

With regard to the roller shutter rod, this task is solved in accordance with the disclosure in that the chamber is designed in two parts in such a way that it enables a hook to be received in two directions opposite to a centre plane of the roller shutter rod.

Advantageous embodiments are the subject of the subclaims and the description.

The disclosure is based on the consideration that it would be advantageous to make a roller shutter rod and a corresponding roller shutter capable of providing effective protection against wind and also against burglary.

As has now been recognised, these criteria can be fulfilled by changing the function of the hook of each roller shutter rod in the chamber of the roller shutter rod above in such a way that the roller shutter rods no longer stand on top of each other in as vertical a geometry as possible—as previously desired with conventional roller shutters—but on the contrary take on a “zig-zag shape”.

The shape of the hook and the chamber on the rod above it ensure that the lowest rod performs a tilting movement in one direction and all the rods above it perform a tilting movement alternately in the opposite direction.

The technical solution is therefore that the chamber is divided into two parts in such a way that when the roller shutter bars are closed, the bar underneath runs into one of the two chambers. As the upper rod continues to move downwards, the hook on the rod underneath causes it to rotate or tilt. On the one hand, this rotating or tilting movement causes the rod to “wedge” in the guide rail. Secondly, the rotating or tilting movement of the upper rod causes its hook to move in such a way that it slides into the other of the two chambers on the rod above. In the further course of the downward movement, a rotating or tilting movement in the opposite direction is generated or forced on the third rod.

When the roller shutter is installed, an outer area of the roller shutter, i.e. an area that corresponds to the outer area of the wall or housing in the installed state, is located essentially on one side of the centre plane, while an inner area is located on the other side of the centre plane. The respective hook is preferably located in a plane perpendicular to the centre plane.

A position of the hook is understood here in particular to be a position in which outward and/or inward rotation of the hook is prevented. Advantageously, exactly two opposing positions are realised, whereby the rotation of the hook in one direction is prevented in a first position, and whereby rotation in the opposite direction is prevented in a second and opposing position.

The term “roller shutter bar” used in this application also includes a “roller shutter door bar”, and the term “roller shutter” also includes a roller shutter door.

Advantageously, the hook is located at the head end and the chamber at the foot end.

Due to its shape, the lower chamber for holding the hook attached to the roller shutter rod underneath forces the rod underneath to tilt in the direction already determined by its position and continues to do so by moving it downwards, while at the same time causing this rod to rotate in the opposite direction.

In a preferred embodiment, the chamber has an internal profile inside the body facing the head end, which is formed in cross-section, in particular in a plane perpendicular to the centre plane, as two curved segments arranged next to each other. The chamber is thus formed with a double-curved upper wall. This wall preferably has two, which, due to their shape, press the latter further and further in the intended direction (outside/inside) when in contact with the hook of the underlying rod during the closing process and thus generate and reinforce the turning or tilting movement. The chamber is preferably formed in such a way that one cam segment lies essentially on one side of the centre plane and the other cam segment on the other side of the centre plane.

The head end preferably has two surfaces that are bevelled towards each other and converge towards a common tip on which the hook is arranged. The shoulders are therefore preferably designed in such a way that they force and encourage the rod above them to tilt in the opposite direction to the direction of rotation of this rod. By alternately tilting (rotating) the individual rods in two opposite directions (inwards and outwards or front and back in the assembled state), the weight force acting vertically from above is alternately diverted outwards and inwards onto the wall of the guide rail.

The two surfaces are advantageously formed in the shape of a roof in relation to a centre plane of the body of the roller shutter rod.

In a preferred embodiment, the roller shutter rod has a foot-shaped design, with the chamber in the foot tip at the foot end and the hook at the head end. This improves the possible properties of conventional roller shutters and roller doors with regard to their sealing properties (gas, smoke, water).

In a further preferred design, the roller shutter rod has a foot-shaped design, with the chamber at the head end and the hook at the foot end.

With regard to the roller shutter, this problem is solved according to the invention with a roller shutter with roller shutter bars as described above.

In a first preferred variant of the roller shutter, it has a plurality of roller shutter bars in which the hook is arranged at the head end and the chamber at the foot end as described above.

When the roller shutter is closed, the hooks tilt advantageously in opposite directions to the centre plane of the roller shutter rod in whose chamber they are arranged by an angle of between 8° and 14°, in particular 12°.

In a second preferred variant of the roller shutter, this has a plurality of the two variants of the roller shutter bars with a foot-shaped design.

In both variants, the roller shutter preferably has guide rails. In a preferred variant, the roller shutter comprises laterally inserted end pieces or locking pieces, which are designed in such a way that they hook into a guide rail, in particular a commercially available guide rail, behind the channel or behind a bar provided for this purpose by means of an inward and outward rotary movement.

The advantages of the invention lie in particular in the fact that the wedging by rotation means that the roller shutter rattles less when exposed to wind than is the case with previous roller shutters, as the blind is pressed against the guide rail at many points on the inside and outside. This advantage is becoming increasingly important in building construction as the effect of wind increases, partly due to climatic changes. Furthermore, this function automatically secures the roller shutter against being pushed up.

If the roller shutter is lowered, the weight of the blind triggers the bars to tilt. If an attempt is made to lift the roller shutter from below, the wedging is intensified. The more force is applied to push the shutter up from below, the more wedging occurs. The roller shutter jams in the guide rail. The anti-jamming effect can be increased by the design of the guide rail and by other measures. Jamming is stopped by removing the force.

The two effects mentioned above are achieved solely by simply changing the profile shape of the roller shutter or roller door bar and can be achieved for all roller shutter systems currently in use at practically no additional cost. This makes the invention possible everywhere in the manufacture of roller shutters.

By tilting (rotating) the individual rods inwards and outwards (front and back) alternately or in opposite directions, a force acting from below (e.g. pushing upwards) is diverted alternately outwards and inwards onto the wall of the guide rail so that the roller shutter or roller door cannot be moved in this direction (anti-lift device).

### BRIEF DESCRIPTION OF THE DRAWINGS

An embodiment of the disclosures is explained in more detail with the aid of a drawing. This shows a highly schematised representation:

FIG. 1 illustrates a roller shutter rod according to the prior art;

FIG. 2 illustrates a roller shutter according to the prior art in two different configurations;

FIG. 3 illustrates a roller shutter according to the prior art;

FIG. 4 illustrates a roller shutter rod in a preferred embodiment;

FIG. 5 illustrates two interconnected roller shutter bars as shown in FIG. 4;

FIG. 6 illustrates three interconnected roller shutter bars according to FIG. 4 in two different configurations;

FIG. 7 illustrates three interconnected roller shutter bars according to FIG. 4 in two different configurations;

FIG. 8 illustrates three interconnected roller shutter bars in two configurations, and

FIG. 9 illustrates end pieces on both sides of every second roller shutter rod, e.g. made of plastic, which hook when the rods are tilted.

Identical parts are labelled with the same reference signs in all figures.

### DETAILED DESCRIPTION

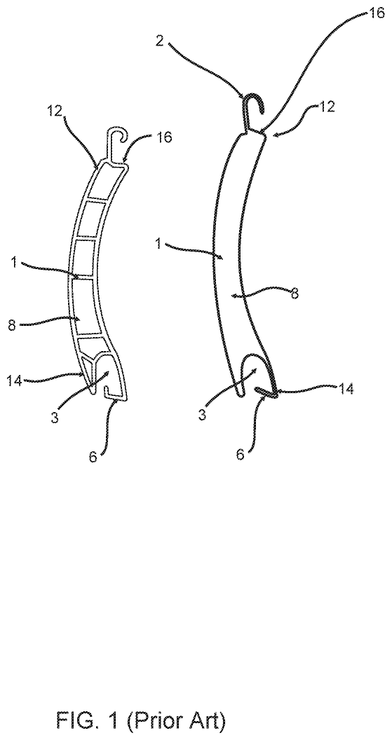

FIG. 1 shows an exemplary roller shutter rod 1 or roller shutter element, with the lefthand illustration showing a cross-section through a commercially available plastic roller shutter rod and the right-hand illustration showing an equally commercially available roller shutter rod made of roll-formed aluminium profiles. The roller shutter rod 1 has a body 8 with an arched cross-section. A hook 2 is attached to one end 12 of the roller shutter rod 1. The roller shutter rod 1 has at least one end face 16 at the head end 12. A chamber 3 for receiving the hook 2 is arranged at a foot end 14 of the roller shutter rod 1 and has a base 6.

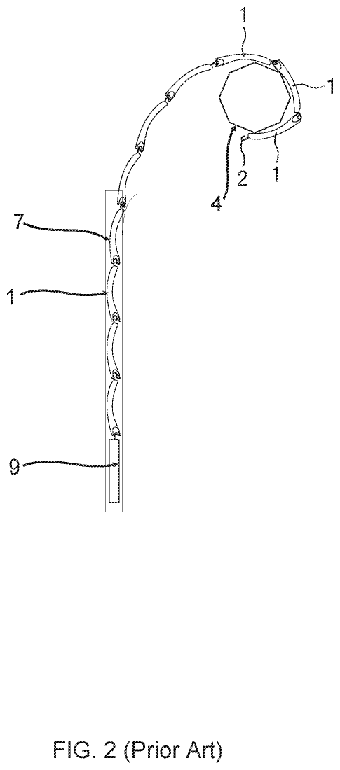

In FIG. 2, a roller shutter 20 is shown which comprises a plurality of roller shutter rods 1 according to FIG. 1 (of which only four are provided with the reference sign 1 for the sake of clarity) as well as a so-called end rod 9 as the lower end. The hook profile of the hook 2 at the upper end or head end 12 of the roller shutter rod 1 and the counterpart or foot end 14 of the chamber 3 or hollow chamber on the lower chamber of the roller shutter rod 1 above are shaped in such a way that they connect the roller shutter rods 1 to one another in an articulated manner. This allows the roller shutter 20 to roll up onto a shaft 4 of the roller shutter. The roller shutter 20 comprises a guide rail 7 for the roller shutter rods 1.

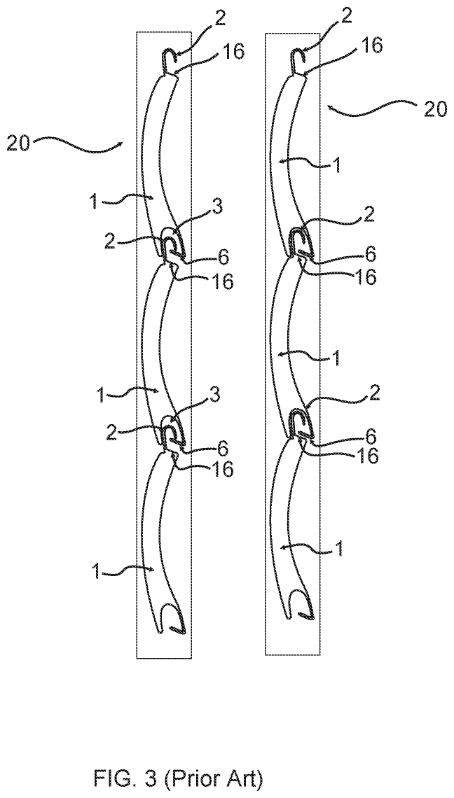

In FIG. 3, the prior art roller shutter 20 according to FIG. 2 is shown in a first configuration on the left and a second configuration on the right, the left configuration showing the roller shutter 20 in the extended state and the configuration on the right showing the roller shutter 20 in the closed state. The roller shutter 20 has a plurality of roller shutter rods 1 as shown in FIG. 1, three of which are shown in each case. The hook 2 of a roller shutter rod 1 is inserted into the chamber 3 of the roller shutter rod 1 arranged above it. The chamber 3 is designed in such a way that, when extended, the hook 2 of the underlying roller shutter rod 1 is hooked in and does not come out of the chamber 3 during normal operation.

In the closed configuration (right in FIG. 3), the base 6 of a roller shutter rod 1 rests on an end face 16 of the roller shutter rod 1 arranged below it. Since the end face 16 and the base 6 each have the same inclination, the roller shutter rods 1 are arranged straight in the closed configuration, i.e. they have essentially the same orientation as in the open or extended state.

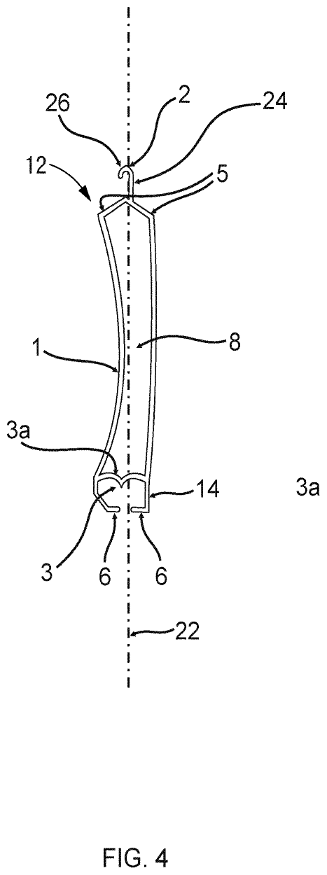

FIG. 4 shows a roller shutter rod 1 in a preferred embodiment of the disclosure. In contrast to the shutter rod 1 shown in FIG. 1, the body 8 of the shutter rod 1 is straight, i.e. it is essentially rectangular in lateral cross-section. At the head end 12, the roller shutter rod 1 has two end faces or surfaces 5, which are symmetrically arranged or angled to a centre plane 22 of the roller shutter rod 1 or its body 8. The centre plane 22 is perpendicular to the plane of the drawing. The two surfaces 5 form a roof-shaped head end 12 of the roller shutter rod 1.

The hook 2 has a first hook part 24, which runs straight, i.e. along the centre plane 22, and an adjoining second, curved hook part 26.

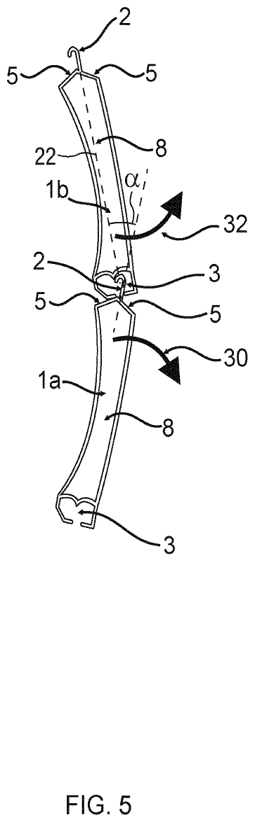

A chamber 3 is formed at the foot end 14 of the roller shutter rod 1, which has two soles 6 and an upper wall 3a, which has two neighbouring curved segments or curve segments in cross-section. The design of the hook 2 and the chamber 3, as shown in FIG. 5 with two shutter rods, which are provided with the reference signs 1a and 1b, enables the shutter rods 1 to tilt (rotate) in opposite directions to one another, which is supported by the inclination of the “shoulder” or respective surface 5 of the shutter rod 1 and the respective base 6 of the shutter rod 1 above it. In the assembled state, the tilting is reinforced by the weight of the roller shutter rods 1 above. This rotation of the roller shutter rods 1 caused by tilting means that the blind is supported alternately inwards and outwards on the guide rail 7.

The bottom bar or the end bar 9 of a roller shutter 1 (blind) installed as the bottom bar of a roller shutter, when it rests on its lower boundary (e.g. window sill, end bar), tilts in a predetermined direction until the tilting movement is stopped by the shoulder or surface 5 of this end bar 9 striking the lateral guide rails 7.

The roller shutter bar 1 above, if it is positioned on the previously described

The roller shutter bar 1 or the end bar 9, respectively, performs a tilting movement in the opposite or counter-rotating direction until it is again limited by the opposite leg of the guide rail 7. This counter-rotating tilting movement is shown in FIG. 5 with the aid of two curved arrows 30, 32.

Furthermore, the third roller shutter rod 1 seen from below lowers onto the second roller shutter rod 1. In the same but opposite direction, the third roller shutter rod 1 now tilts from below in the same direction as the first roller shutter rod 1 from below. The same happens again in the opposite direction with the fourth roller shutter rod 1 (seen from below), etc.

In the embodiment shown in FIG. 5, the reciprocal tilting movement causes the individual roller shutter rods 1a, 1b to wedge in the guide rail in two opposite directions, correspondingly outwards and inwards in the assembled state in a wall, in order to make it more difficult to push up, to increase the resistance to the effects of wind and to prevent rattling. In this design, all roller shutter rods 1a, 1b are identical with the exception of the lower end rod (not shown), so only a single design of roller shutter rod 1a, 1b is shown for the manufacture of a roller shutter.

The tilting movement causes one of the hooks 2 to tilt relative to the centre plane 22 by an angle α (see FIG. 5). In a preferred embodiment, this angle is between 1° and 60°, even more preferably between 5° and 30°, preferably between 10° and 14°, particularly preferably at 12°.

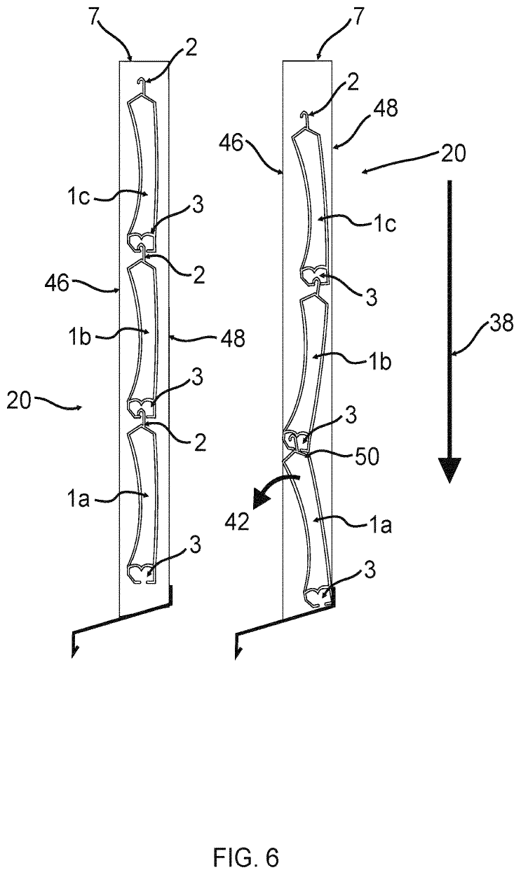

FIG. 6 shows a section of a roller shutter 20 with three interconnected roller shutter rods 1a, 1b, 1c in two configurations. In the extended configuration shown on the left, roller shutter rod 1b hangs on roller shutter rod 1c, and roller shutter rod 1a hangs on roller shutter rod 1b.

In the right-hand configuration, the roller shutter 20 is shown during the closing process. A window sill 36 is shown at the bottom, which does not run horizontally but rises from left to right, as is usually the case in practice. The closing process, during which the roller shutter bars 1a, 1b, 1c are moved downwards, is shown by an arrow 38.

The lowest roller shutter rod 1a has rested on the window sill 36 and is tilted to the left against the left limit of the guide rail 7 (shown by a curved arrow 42). The hook 2 of the shutter rod 1a is arranged in the left part of the chamber 3 and is supported on the curved interior of the chamber. The lowest roller shutter rod 1a of the roller shutter 20 (curtain), when it rests on its lower boundary (e.g. window sill 36, end rod), therefore tilts in a predetermined direction until the tilting movement is stopped by the shoulder 44 of this roller shutter rod 1a striking a lateral leg 46 of guide rail 7.

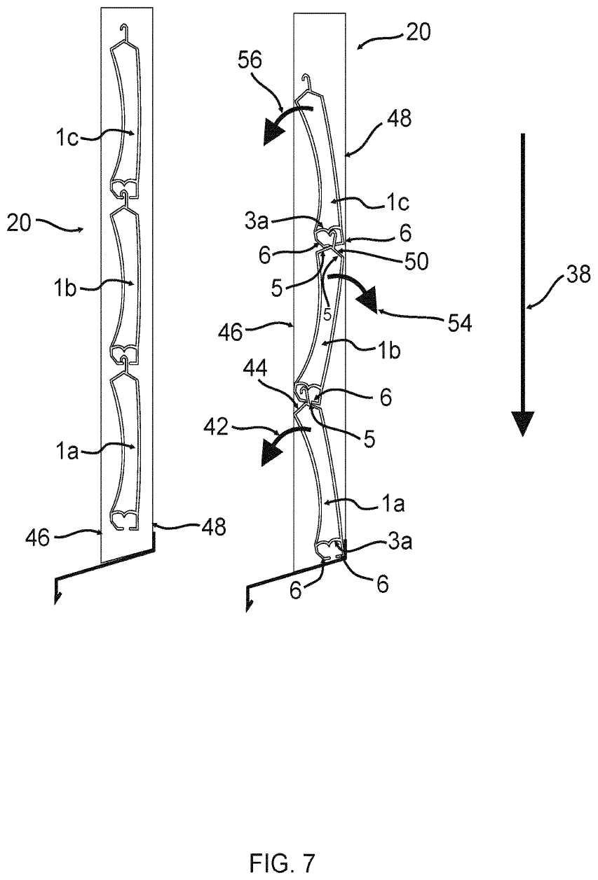

The shutter rod 1b above it, when it rests on the previously described shutter rod 1a, performs a tilting movement (illustrated by arrow 54) in the opposite or counter-rotating direction until this is in turn limited by the opposite leg 48 of the guide rail, in that the shoulder 50 opposite the shoulder 44 rests against the leg 48 of the guide rail, see the configuration of the shutter 20 shown on the right in FIG. 7. The third shutter rod 1c, as seen from below, lowers onto the second shutter rod 1b. In the same but opposite manner, the third roller shutter rod 1c now tilts from below in the same direction as the first roller shutter rod 1a from below. The fourth roller shutter rod (seen from below; not shown) does the same in the opposite direction, etc.

The effect of reciprocal tilting (rotation) is achieved by the hook 2 of the lower, already tilted rod 1a being forced further in the direction of its existing tilting by the upper wall 3a of the chamber 3 of the rod 1b above it. At the same time, the shape of the wall 3a of the hollow chamber causes the upper roller shutter rod 1b to tilt in the opposite direction to the underlying roller shutter rod 1a. The formation of surfaces 5 of the shoulders 44 and base 6 on each roller shutter profile favours the further tilting (rotation) of the roller shutter rods 1a, 1b, 1c in the respective predetermined direction and enables tight closing in the lowered state.

When the roller shutter is fully closed, it is supported over its entire height by the rotation of the individual roller shutter rods 1a, 1b, 1c backwards and forwards or outwards and inwards in the guide rail 7. As a result, the roller shutter rods 1a, 1b, 1c have no outward or inward play in the guide rail 7. In contrast to conventional roller shutters, there is therefore no rattling when exposed to wind. If the roller shutter 20 is lifted from below, e.g. during an attempted break-in, this force acts against the weight force, but in the same way has the effect that the roller shutter bars 1a, 1b, 1c rotate upwards from below (upsetting) and thus jam in the guide rail 7, which prevents them from being pushed upwards. This functionality is possible with belt, crank and motor, but not with operation by spring shafts.

In a further preferred embodiment, the guide rail and/or the roller shutter bars or connecting elements between the two can be explicitly manufactured using a more elastic material, for example plastic with a certain elasticity up to materials such as neoprene. This is particularly advantageous when a very high resistance is required, e.g. against water (flood protection). The jamming in the guide rail increases with elastic materials during upsetting and thus ensures even greater tightness.

In the case of spring shafts, the winding process is carried out by a torsion or strip spring in or on the winding shaft, which counteracts the weight force. If the roller shutter is moved downwards, the spring is tensioned and wants to roll the roller shutter upwards again. As a result, the tensile force of the spring permanently acts on the fully closed roller shutter curtain (which is usually locked in the end rod). The function of tilting or rotating the bars triggered by the weight of the roller shutter bars is therefore not given.

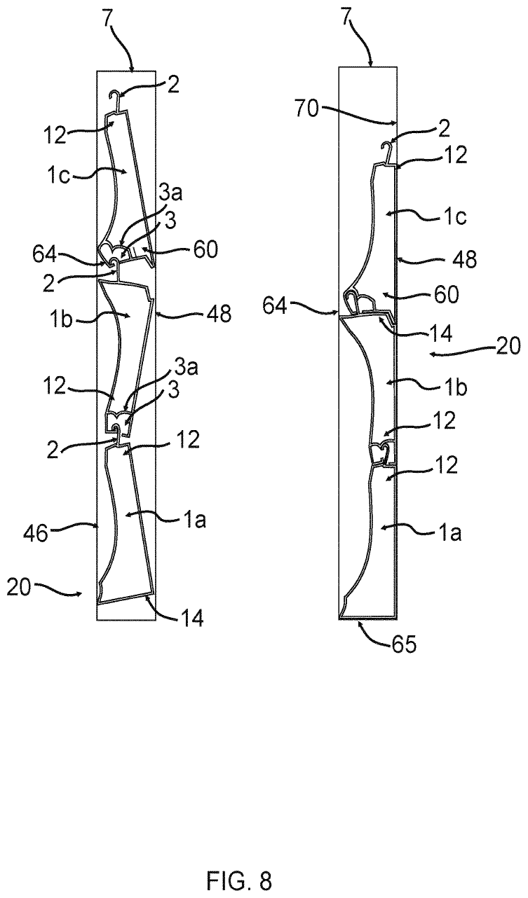

In FIG. 8, a roller shutter 20 is shown in a further preferred embodiment in an unrolled configuration (left) and in a closed state (right). Three roller shutter bars 1a, 1b, 1c are shown in each case. In this embodiment of the roller shutter 20, three different roller shutter rods 1a, 1b, 1c are used.

The rod 1a is the so-called end rod, i.e. the lowest rod of the roller shutter or roller door. It is characterised by the fact that it adapts to the lower surface on which it rests in such a way that the rotation of the rod 1b above it is forced in the opposite direction. As a result, the surfaces of the end rod 1a facing the sealing plane and the rod 1b above it form as smooth a surface as possible, which is pressed further against the sealing plane 70 (inside of the guide rail or the seal fitted therein) by the rotation of the rods. At the same time, the rotation of rod 1b and the closing process force the rotation of rod 1c in the opposite direction to that of rod 1b, so that its side facing the sealing plane is also pressed against the sealing plane.

A first variant of roller shutter rod 1a, 1c comprises a hook 2 attached to a head end 12. The foot end 14 of the roller shutter rod 1a, 1c is foot-shaped with a heel part 60 and a toe part 64, in which the chamber 3 is arranged. The chamber 3 has a cross-section on a wall 3a inside the toe part 64, which has two neighbouring curved segments.

A second variant of the roller shutter rod 1b has a chamber 3 at the head end 12. The chamber 3 has a cross-section on a wall 3a inside the base tip part 64, which has two neighbouring circular segments. The hook 2 is arranged at the base end 14. In the closed configuration shown on the right, the top part 12 of roller shutter rod 1a and the top part 12 of roller shutter rod 1b lie on top of each other, with the hook 2 of roller shutter rod 1a being arranged in the chamber of roller shutter rod 1b. The foot end 14 of the roller shutter rod 1b rests on the foot end 14 of the roller shutter rod 1c. In this way, a sealing plane 70 is formed. A roller shutter or roller door with high resistance to water (flood protection, shipbuilding) or with increased air and smoke tightness (thermal insulation, fire protection) is formed.

By using suitable guide rails and end pieces at the rod ends (locking pieces), the rotation of the roller shutter rods can also contribute to improved wind protection of the roller shutter rods, e.g. during storms. Due to the support over the entire height, the use of this system can bring corresponding advantages in mobile applications, especially in vehicle construction.

In the design shown in FIG. 8, the same effect (mutual tilting and wedging of the rods in the guide rail) is utilised by alternately using two different roller shutter rods that belong together in order to achieve as flat and tight a seal as possible to the guide rail (e.g. against a rubber or neoprene insert) on one of the two end levels (outside or inside). In practice, this is used, for example, for flood protection, smoke sealing or to achieve better temperature insulation of a roller shutter or roller door.

When a force is applied from the direction of the contact surface (water pressure, wind pressure), the profile design of the bar increases the reciprocal tilting (rotation), whereby the surface of the roller shutter or roller shutter door bar is pressed more strongly against the wall of the guide rail facing the direction of pressure (flood protection, tightness, smoke protection).

In the variant shown in FIG. 8, the counter-rotation is intended to ensure that the alternately differently shaped roller shutter bars press as closely as possible against one side of the guide rail in order to achieve the best possible sealing function.

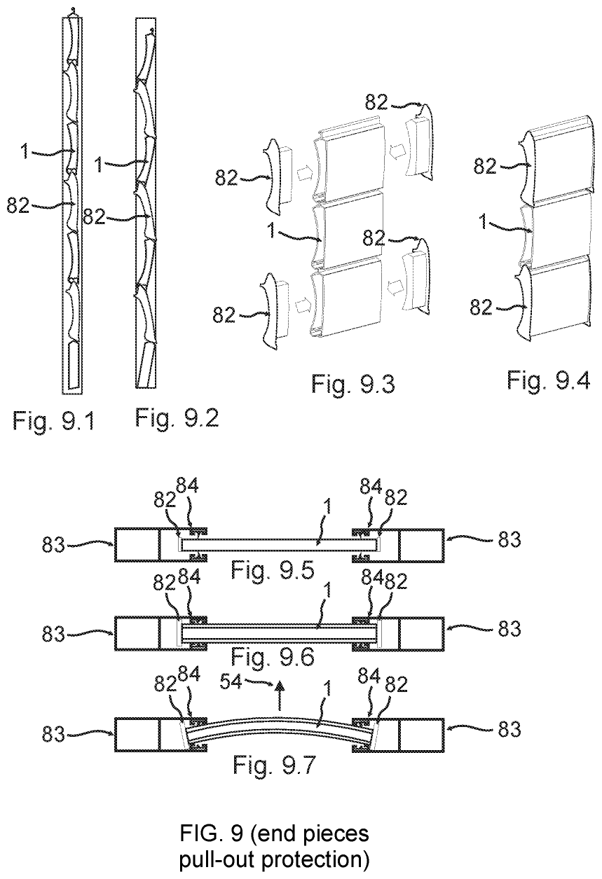

FIG. 9 shows a preferred embodiment which can be used if special requirements are placed on wind stability or burglary protection. Specially shaped end pieces or locking pieces 82, e.g. made of wire, plastic or metal, are attached to the lateral ends of the roller shutter bars. When using guide rails 83 with piping inserts inserted into piping grooves 84, which are often used today, or also special moulded guide rails with bars, the protruding parts of these end pieces can be placed behind the piping or possibly bars of the guide rails due to the rotation of the roller shutter bars. This makes it even more difficult to prevent the roller shutter curtain from being torn out by external forces (e.g. wind, manual action, water pressure). The fact that these lateral end pieces are higher than the nominal thickness of the roller shutter rod allows them to swing out further than the roller shutter rod itself as the roller shutter rod rotates. Thus, the function of hooking the locking pieces 82 behind a specially shaped bar or, as shown in FIG. 9.7, behind the protruding channel 84 of a commercially available roller shutter guide rail 83 is triggered as soon as the roller shutter or roller door is fully closed. This design is suitable for roller shutters and in some cases also for roller shutters made of aluminium.

FIGS. 9.1 and 9.2 show the end or locking pieces, which are located on every second roller shutter rod 1 (shown in grey). In FIG. 9.1, the roller shutter is shown in hanging form, i.e. also during movement in the up or down direction. The rods 1 of the roller shutter as well as the locking pieces 82 are located in the area of the clear opening of the guide rail 83. FIG. 9.2. shows the roller shutter in closed form, i.e. with rotated roller shutter rods. The locking pieces 82 thus protrude beyond the clear width of the guide rail 83.

FIG. 9.3 shows how the locking pieces 83 are pushed laterally onto every second bar of the roller shutter from both sides. FIG. 9.4. shows these locking pieces in the pushed-in state.

FIG. 9.5 describes the rotation and load prolapse. In the top picture, the roller shutter is shown hanging, i.e. also during movement in the up or down direction. The roller shutter rods 1 together with the locking pieces 82 located on both sides can move freely in the guide rail.

FIG. 9.6 shows the roller shutter in the closed state, i.e. with rotated rods. The rotated roller shutter rods jam in the guide rails between the piping aisles 84. The rotation of the rods 1 also causes the laterally mounted locking pieces 82 to rotate. Due to the fact that the locking pieces are higher than the roller shutter rods, their swivelling range caused by the rotation is also larger. The ends of the locking pieces therefore swivel into an area behind the piping aisles 84.

If, as shown in FIG. 9.7, a load is applied to the roller shutter in a direction perpendicular to the hanging surface 54, e.g. by wind or water load or by an attempted break-in (pulling out), the swivelled locking pieces 82 additionally prevent the bars 1 from being torn out because the locking pieces 82 are caught behind the piping channels 84.

### LIST OF REFERENCE SYMBOLS

1, 1a, 1b, 1c Roller shutter bar α Angle
2 Hook
3 Chamber
3a Wall
4 Shaft
5 Surface area
6 Sole
7 Guide rail
8 Body
9 Tail bar
12 Head end
14 Foot end
16 Front face
20 Roller shutter
22 Centre plane
24 First hook part
26 Second hook part
30, 32 Arrow
36 Window sill
38, 42 Arrow
44 Shoulder
46, 48 Thigh
50 Shoulder
54, 56 Arrow
60 Heel part
64 Toe section
65 Contact surface
70 Density level
82 Locking piece
83 Standard roller shutter guide rail
84 Kedergasse

1. A roller shutter rod, comprising:
a body having a head end and a foot end, wherein a hook is arranged at one of the two ends of the body and a chamber for receiving the hook is formed at the other of the two ends, and
wherein the chamber is formed in two parts in such a way that it enables the hook to be received in two directions opposite to a centre plane of the roller shutter rod.

2. The roller shutter rod according to claim 1, wherein the hook is arranged at the head end and the chamber is arranged at the foot end.

3. The roller shutter rod according to claim 2, wherein the chamber has an inner profile inside the body facing the head end, which is formed in cross-section as two curved segments arranged next to each other.

4. The roller shutter rod according to claim 3, wherein the head end has two surfaces which are beveled towards each other and converge towards a common tip on which the hook is arranged.

5. The roller shutter rod according to claim 4, wherein the two surfaces are formed roof-shaped symmetrically to a centre plane of the body of the roller shutter rod.

6. The roller shutter rod according to claim 1, wherein the body has a foot-shaped design having a foot tip, and the chamber is arranged in the foot tip at the foot end and the hook is arranged at the head end.

7. The roller shutter rod according to claim 1, wherein the body has a foot-shaped design, and the chamber is arranged at the head end and the hook at the foot end.

8. A roller shutter, comprising a plurality of roller shutter rods according to claim 1.

9. The roller shutter according to claim 8, wherein, in closed state, the hooks tilt in opposite directions in each case to the centre plane of the roller shutter rod, in the chamber of which they are arranged, by an angle which is between approximately 8° and approximately 14°.

10. A roller shutter, comprising a first number of roller shutter rods according to claim 6 and a second number of roller shutter rods, the second number of roller shutter rods each comprising a body having a head end and a foot end, wherein a hook is arranged at the foot end and a chamber for receiving the hook is formed at the head end, and wherein the chamber is formed in two parts in such a way that it enables the hook to be received in two directions opposite to a centre plane of the roller shutter rod.

11. A roller shutter, comprising one or more laterally inserted locking pieces, which are designed in such a way that the one or more locking pieces are hooked into a guide rail behind a piping channel or behind a web provided for this purpose by an inward and outward rotary movement.

12. A roller shutter, comprising a plurality of roller shutter rods according to claim 2.

13. A roller shutter, comprising a plurality of roller shutter rods according to claim 3.

14. A roller shutter, comprising a plurality of roller shutter rods according to claim 4.

15. A roller shutter, comprising a plurality of roller shutter rods according to claim 5.

16. The roller shutter according to claim 9, wherein the angle is approximately 12°.
